(19) United States
(12) Patent Application Publication
(10) Pub. No.: US 2006/0261725 A1
(43) Pub. Date: Nov. 23, 2006

(54) Electron emission device, electron emission display, and manufacturing method of the electron emission device

(76) Inventor: Sang-Jin Lee, Suwon-si (KR)

Correspondence Address: Robert E. Bushnell, Suite 300, 1522 K Street, N.W., Washington, DC, 20005, US

(21) Appl. No.: 11/436,654

(22) Filed: May 19, 2006

(30) Foreign Application Priority Data
May 19, 2005 (KR) 10-2005-041982

(51) Int. Cl. H01J 1/62; H01J 63/04; H01J 9/24; H01J 9/00

(52) U.S. Cl. 313/495; 313/497; 445/24

(57) ABSTRACT

An electron emission device may be constructed with a substrate, cathode electrodes formed on the substrate along one direction of the substrate, gate electrodes crossing perpendicularly over the cathode electrodes with an insulating layer interposed between the gate and cathode electrodes, openings formed through the gate electrodes and the insulating layer, and electron emission regions placed on the cathode electrodes within the corresponding openings. Each gate electrode includes a main body, isolated portions surrounding the respective electron emission regions and isolated from the main body with a distance, and a connector interconnecting at least one of the isolated portions and the main body. The connectors may be selectively removed so that at least one of the isolated portions is electrically insulated from the main body, in order to thereby enhance the light emission uniformity per pixel.

### CLAIM OF PRIORITY

This application makes reference to, incorporates the same herein, and claims all benefits accruing under 35 U.S.C.§119 from an application entitled Electron Emission Device, Electron Emission Display, And Manufacturing Method Of The Electron Emission Device earlier filed in the Korean Intellectual Property Office on the 19^{th} of May 2005 and there duly assigned Serial No. 10-2005-0041982.

### BACKGROUND OF THE INVENTION

1. Field of the Invention

The present invention relates to electron emission devices and to devices incorporating electron emission devices generally, and in particular, to electron emission devices having gate electrodes constructed with an enhanced structure to improve the light emission uniformity per pixel, and methods for manufacturing electron emission devices and electron emission displays using these electron emission devices.

2. Description of the Related Art

Generally, electron emission elements are classified on the basis of the type of electron source which they employ, as either a first type using a hot cathode, or a second type using a cold cathode.

Among the second type electron emission elements which use a cold cathode, are a field emission array (FEA) type, a surface conduction emission (SCE) type, a metal-insulator-metal (MIM) type, and a metal-insulator-semiconductor (MIS) type.

The FEA-type electron emission element has electron emission regions, and has a cathode electrode and a gate electrode as its driving electrodes. The electron emission regions are formed with a material having either a low work function or a high aspect ratio, such as a carbonaceous material or a nanometer-sized material. The FEA-type electron emission element is based on the principle that when such a material having a low work function or a high aspect ratio is used in the electron emission regions, application of an electric field to the electron emission regions held under a vacuum atmosphere enables the emission of electrons from the electron emission regions.

Arrays of the electron emission elements are arranged on a first substrate to form an electron emission unit, which, in turn, forms an electron emission device together with the first substrate. A light emission unit is formed with phosphor and black layers on a surface of a second substrate facing the first substrate, an anode electrode, etc. The light emission unit formed on the second substrate is assembled with the electron emission device to thereby construct an electron emission display.

With the common FEA-type electron emission display, cathode electrodes, an insulating layer, and the gate electrodes are sequentially formed on the first substrate, and openings are formed at the gate electrodes and the insulating layer in correspondence with the respective crossed regions of the cathode and the gate electrodes. Electron emission regions are formed on the cathode electrodes within the openings. Phosphor and black layers, and an anode electrode are formed on a surface of the second substrate facing the first substrate.

When predetermined driving voltages are applied to the cathode and the gate electrodes, electric fields are formed around the electron emission regions at the pixels where the voltage difference between the two electrodes exceeds a threshold value, and electrons are emitted from those electron emission regions. The emitted electrons are attracted by the high voltage of about several kilovolts (kV) applied to the anode electrode, and accelerated toward the second substrate, followed by excitation of the phosphors at the relevant pixels and displaying the desired images.

With the structure for an electron emission display discussed in the foregoing paragraphs, it is very difficult to reliably and uniformly fabricate all of the cathode electrodes, the gate electrodes, the electron emission regions, and other structural features of the emission device. Specifically, in constructing a device with a plurality of electron emission regions formed at each pixel, many difficulties are encountered in endeavors to heighten the uniformity of shape (i.e., to provide “shape uniformity”) of the respective structural components. The factors contributing to non-uniformity deleteriously effect the uniformity of light emission per pixel and the accompanying display image quality.

### SUMMARY OF THE INVENTION

It is therefore, one object of the present invention to provide an improved electron emission device.

It is another object to provide an electron emission device endowed with a greater shape uniformity between its structural components.

It is still another object to provide an electron emission device able to enhance the uniformity of electron emission by each pixel.

It is yet another object to provide a method of manufacturing an electron emission device able to enhance the uniformity of electron emission by each pixel.

It is a further object to provide an electron emission display constructed with an electron emission device able to enhance the uniformity of electron emission by each pixel.

In one exemplary embodiment of the present invention, there is provided an electron emission device that heightens the electron emission uniformity per pixel, a method of manufacturing the electron emission device, and an electron emission display using the electron emission device.

According to one exemplary embodiment of the present invention, an electron emission device includes a substrate, cathode electrodes formed on the substrate in a direction of the substrate, gate electrodes crossing over the cathode electrodes while interposing an insulating layer, openings formed in the gate electrodes and the insulating layer, and electron emission regions placed on the cathode electrodes within the respective openings. Each gate electrode has a main body, isolated portions surrounding the respective electron emission regions and isolated from the main body with a distance, and a connector interconnecting at least one of the isolated portions and the main body.

The respective isolated portions may be divided into two or more sub-portions around the relevant opening, and at least one of the divided sub-portions may be connected to the main body via the connector.

The connectors may be selectively cut to control the electron emission uniformity per pixel.

The electron emission device may further include a focusing electrode placed over the gate electrodes while interposing an additional insulating layer. The focusing electrode has openings for passing the electron beams.

According to another exemplary embodiment of the present invention, an electron emission display includes first and second substrates facing each other, cathode electrodes formed on the first substrate in a direction of the first substrate, gate electrodes crossing over the cathode electrodes while interposing an insulating layer, openings formed in the gate electrodes and the insulating layer, electron emission regions placed on the cathode electrodes within the respective openings, phosphor layers formed on a surface of the second substrate, and an anode electrode formed on a surface of the phosphor layers. Each gate electrode has a main body, isolated portions surrounding the respective electron emission regions and isolated from the main body with a distance, and a connector interconnecting at least one of the isolated portions and the main body.

The respective isolated portions may be divided into two or more sub-portions around the relevant opening, and at least one of the divided sub-portions may be connected to the main body via the connector.

The connectors may be selectively cut to control the light emission uniformity of each pixel.

The electron emission display may further include a focusing electrode placed over the gate electrodes while interposing an additional insulating layer. The focusing electrode has openings for passing the electron beams.

According to another exemplary embodiment of the present invention, in a method of manufacturing an electron emission device, cathode electrodes, an insulating layer and main bodies of gate electrodes are first formed on a substrate in a sequential manner. Openings are formed at the main bodies of the gate electrodes and the insulating layer, and simultaneously, isolated portions are formed around the openings such that the isolated portions are spaced apart from the main bodies with a distance, together with connectors interconnecting the main bodies and the isolated portions. Electron emission regions are formed within the respective openings. The light emission uniformity per pixel is tested while applying voltages to the cathode and the gate electrodes. At least one connector is selectively removed from the abnormally bright pixels among the pixels largely differentiated in the light emission uniformity.

The step of forming the isolated portions and the connectors may be conducted simultaneously with the step of forming the main bodies.

The testing of the light emission uniformity per pixel may be made using a white balance tester based on a vacuum chamber.

Alternatively, the testing of the light emission uniformity per pixel maybe made using a white balance tester after the substrate bearing the cathode and another substrate with a light emission unit are assembled and sealed to each other.

The removal of the connectors may be made by a laser, and the connectors may be formed with a width of several to several tens micrometers (μm).

### BRIEF DESCRIPTION OF THE DRAWINGS

A more complete appreciation of the invention and many of the attendant advantages 8 thereof, will be readily apparent as the same becomes better understood by reference to the following detailed description when considered in conjunction with the accompanying drawings in which like reference symbols indicate the same or similar components, wherein:

FIG. 1 is an enlarged, partially cut-away projection view of an electron emission display according to a first embodiment of the present invention.

FIG. 2 is a partial cross-sectional elevational view of the electron emission display according to the first embodiment of the present invention.

FIG. 3 is a plan view of a gate electrode for the electron emission display according to the first embodiment of the present invention.

FIG. 4 is a plan view of the gate electrode shown in FIG. 3 where connectors are partially removed.

FIG. 5 is a plan view of a variant of the gate electrode.

FIG. 6 is a plan view of the gate electrode shown in FIG. 5 with the connectors partially removed.

FIG. 7 is an enlarged, partially cut-away projection view of an electron emission display according to a second embodiment of the present invention.

FIG. 8 is a cross-sectional elevational view of an electron emission display according to a second embodiment of the present invention.

FIG. 9 is a flow chart illustrating the steps for processing an electron emission device according to an embodiment of the present invention.

FIG. 10 is sequence of projection views illustrating the results provided by successive steps during a fabrication process for an electron emission device according to an embodiment of the present invention.

### DETAILED DESCRIPTION OF THE INVENTION

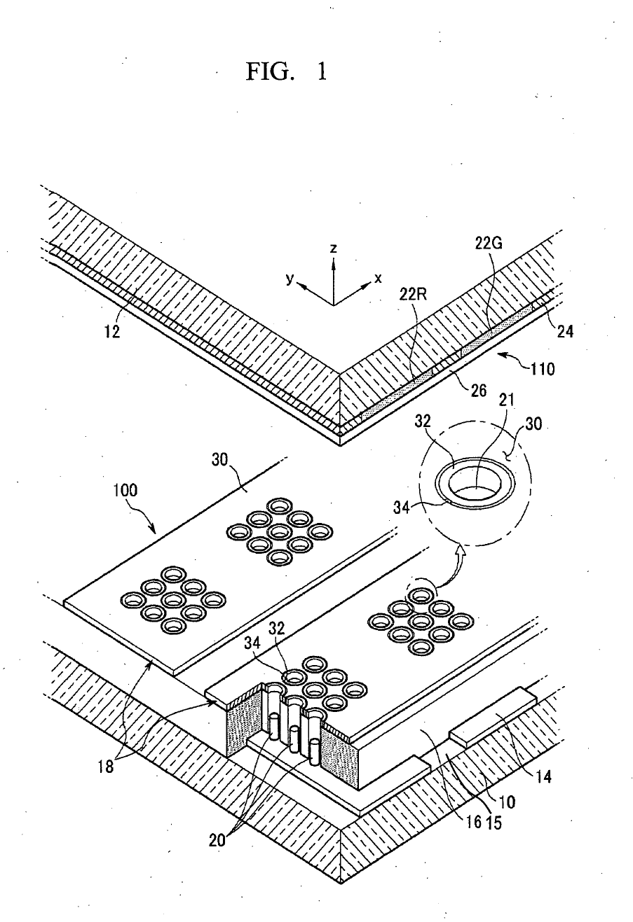

As shown in FIGS. 1 to 3, an electron emission display constructed as a first embodiment according to the principles of the present invention includes first and second substrates 10 and 12 facing each other in parallel while separated by a predetermined distance, an electron emission unit 100 provided on the first substrate 10, and a light emission unit 110 provided on a surface of the second substrate 12 facing the first substrate 10.

A sealing member (not shown) is provided at the peripheries of the first and the second substrates 10 and 12 to seal them, and the internal space between the two substrates 10 and 12 is evacuated to be at 10⁻⁶ Torr, thereby constructing a vacuum vessel with the first and the second substrates 10 and 12 and the sealant.

The electron emission unit 100 includes cathode electrodes 14 placed on the first substrate 10 and spaced apart from each other by gaps 15 in parallel with a predetermined distance, gate electrodes 18 crossing successively over the cathode electrodes 14 while an insulating layer 16 is interposed between cathode electrodes 14 and gate electrodes 18, and electron emission regions 20 formed on cathode electrodes 14 within orifices 21 extending through insulating layer 16 at the crossed regions between cathode and gate electrodes 14 and 18.

When the crossed, or overlapping regions of cathode and the gate electrodes 14 and 18 are defined as pixels, a plurality of electron emission regions 20 are formed on cathode electrodes 14 at the respective pixels. Openings, or orifices 21 are formed through insulating layer 16 and gate electrodes 18 corresponding to the respective electron emission regions 20 to expose electron emission regions 20 to the underlying major surface of first substrate 10.

It is illustrated in the drawings that nine generally circular cylindrically shaped electron emission regions are formed at each pixel in the cumulative shape of square, but the plane shape, number per pixel and arrangement of the electron emission regions 20 are not limited thereto to the specific numbers or geometric constructs illustrated.

Electron emission regions 20 may be formed from a material emitting electrons when an electric field is applied thereto under a vacuum atmosphere, such as a carbonaceous material or a nanometer (nm)-sized material. For instance, electron emission regions 20 may be formed with carbon nanotube, graphite, graphite nanofiber, diamond, diamond-like carbon, fullerene C₆₀, silicon nanowire, or a combination thereof. The formation of the electron emission regions 20 may be made by processes such as screen printing, direct growth, chemical vapor deposition, or sputtering.

Light emission unit 110 will be now explained in detail. Phosphor layers 22 with red, green and blue phosphor layers 22R, 22G and 22B are formed on a major surface of second substrate 12 facing first substrate 10 such that substrates 10, 12 are spaced apart from each other by a distance, and black layer 24 is formed between respective phosphor layers 22 to enhance the screen contrast. Phosphor layers 22 are arranged in a distributed array to that one of the three-colored phosphor layers 22R, 22G and 22B is correspondingly located to extend across each pixel.

Anode electrode 26 is formed on the phosphor and the black layers 22 and 24 with a metallic material such as aluminum Al. Anode electrode 26 receives a high voltage required for accelerating electron beams from the outside to place phosphor layers 22 in a high potential state, and reflects the visible rays radiated from phosphor layers 22 to first substrate 10, toward second substrate 12 in order to heighten the screen luminance.

Meanwhile, anode electrode 26 may be formed with a transparent conductive material such as indium tin oxide (ITO). In this case, anode electrode is placed on a surface of the phosphor and the black layers 22 and 24 and is directed toward second substrate 12. It is also possible that a metallic layer and a transparent conductive layer be simultaneously formed to function as anode electrode 26.

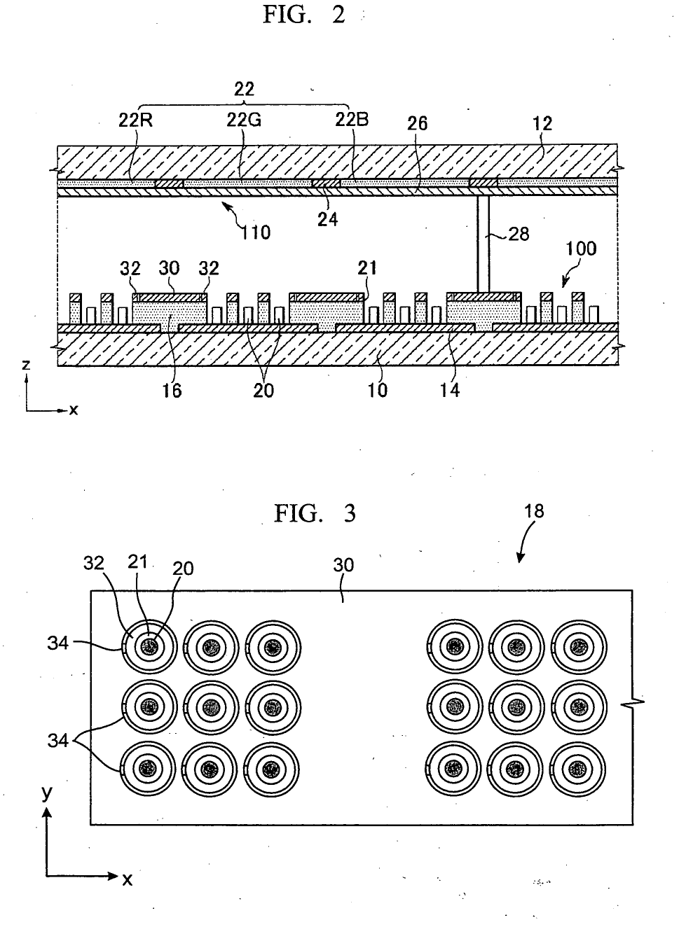

As shown in FIG. 2, spacers 38 are arranged between first and second substrates 10 and 12 to endure the pressure applied to the vacuum vessel and to maintain the distance between the two substrates constant. Spacer 38 is placed at the area of the black layer 24 such that spacer 38 does not intrude upon the area of phosphor layer 22, and may be mainly formed with a dielectric such as glass and ceramic.

In this embodiment, gate electrode 18 is formed with a main body 30, and isolated portions 32 that are isolated from main body 30 by a distance and surround the corresponding electron emission regions 20; connectors 34 electrically interconnecting main body 30 and isolated portions 32.

Isolated portion 32 is formed in the shape of a ring that coaxially corresponds to the shape of the opening 21. Connector 34 may be provided to the corresponding isolated portion 32 placed within each pixel. Alternatively, connector 34 may be omitted at one or more isolated portions 32 within the pixel.

After the identification of the light emission uniformity per pixel such as a white balance, it is possible to selectively cut and remove one or more of connectors 34 in order to control the electron emission uniformity at each pixel.

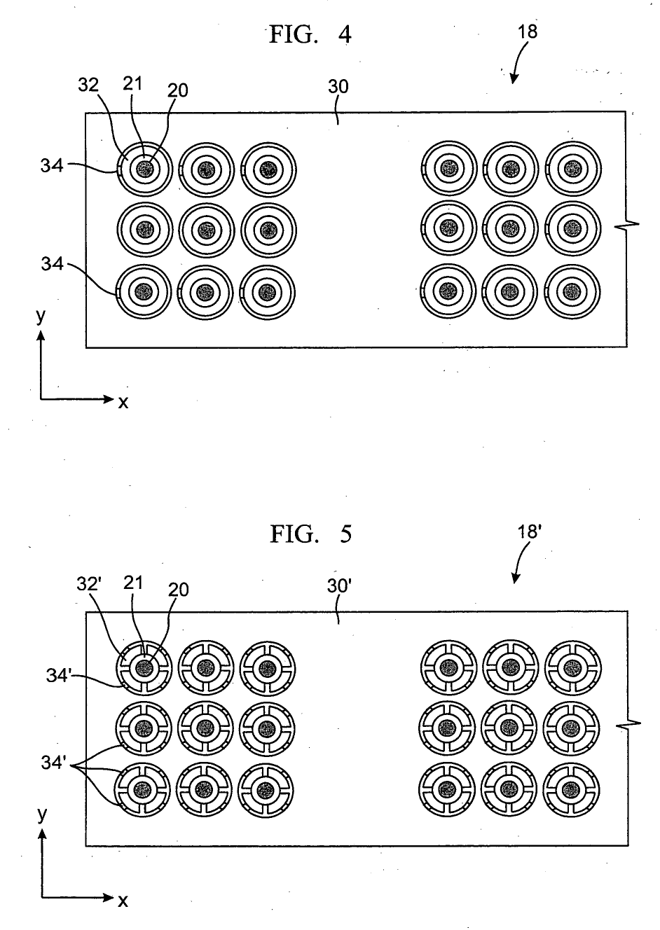

For instance, as shown in FIG. 4, the removal of the connector 34 may be made with respect to the three isolated portions 32 placed at the inner, or central pixel row from among the nine isolated portions 32 corresponding to the nine electron emission regions 20 of the left-sided pixel based shown in the drawing. Isolated portion 32 with no connector 34 is electrically insulated from main body 30, and voltage applied to anode electrode is not applied thereto. Accordingly, the electric field created by way of gate electrode 18 is either not formed or is weakly formed around the electron emission region 20 surrounded by that isolated portion 32, and the number of electrons emitted from the electron emission region 20 is concomitantly reduced.

Consequently, it is possible to control the amount of electron emission and the luminance of each pixel by removing one or more connectors 34 from the those pixels that are overly bright (that is, from those pixels with a high luminance) in comparison to other pixels.

The difference in the light emission uniformity per pixel is usually made due to one or more of such factors as the local non-uniformity in the dimension of the electrical currents applied to cathode and gate electrodes 14, 18, the shape non-uniformity of electron emission regions 20, and the non-uniformity in the amount of electron emission.

With the inventive structure, it is possible to control the intensity in the electric field around electron emission regions 20 by selectively isolating isolated portions 32 of gate electrode 18 from main body 30 thereof, and to thereby enhance the whole light emission uniformity per pixel.

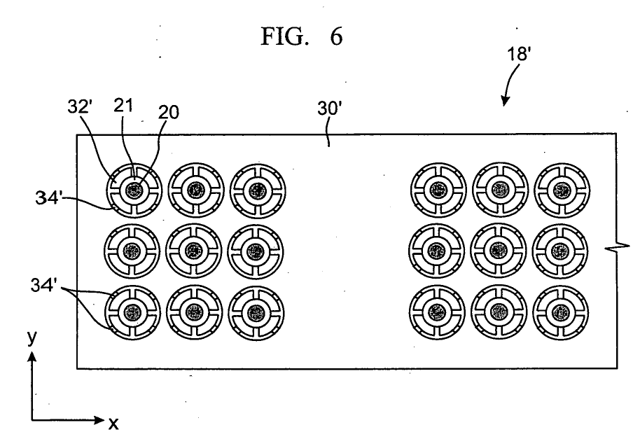

FIG. 5 shows a variant of the gate electrode 18′. As shown in FIG. 5, two or more isolated portions 32′ (for example, four isolated portions 32′) may be provided around the periphery of opening 21, and in this case, the respective isolated portions 32′ are connected to the main body 30′ using connectors 34′. With this structure for isolated portions 32′, it becomes possible as shown in FIG. 6, to control the number of isolated portions 32′ related to one electron emission region 20, which are cut and electrically insulated from main body 30′. As it is also illustrated in FIG. 6, the lower-sided two isolated portions 32′ among the isolated portions 32′ placed at the central row of the left-sided pixel may be cut, thereby electrically insulated isolated portions 32′ from main body 30′.

In this case, it is possible to control the light emission uniformity per pixel more precisely, compared to the previously-described structure where one isolated portion 32 is provided at each electron emission region 20.

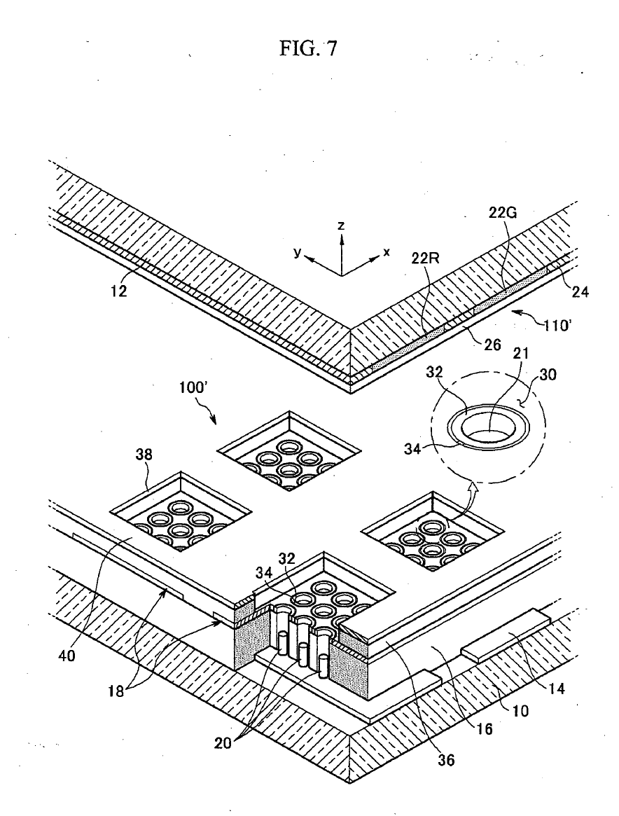

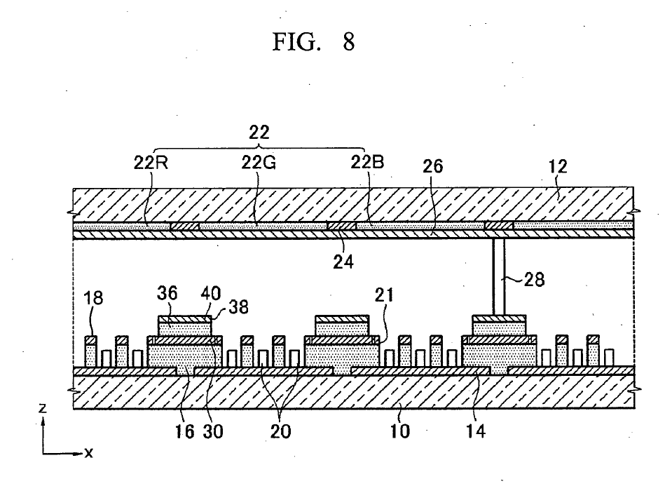

As shown in FIGS. 7 and 8, an electron emission display according to a second embodiment of the present invention may have the same basic structural components as those related to the first embodiment. The electron emission display further has focusing electrode 40 formed over cathode and gate electrodes 14 and 18 of first substrate 10 while interposing an additional insulating layer 36 between cathode and gate electrodes 14 and 18. Focusing electrode 40 is perforated by openings 38 aligned with the corresponding pixels to accommodate passage of the electron beams.

Focusing electrode 40 focuses the electrons emitted from electron emission regions 20, and prevents electron emission regions 20 from being influenced by the anode electric field.

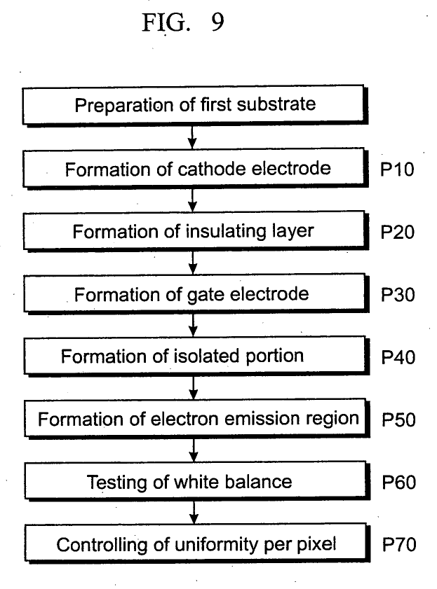

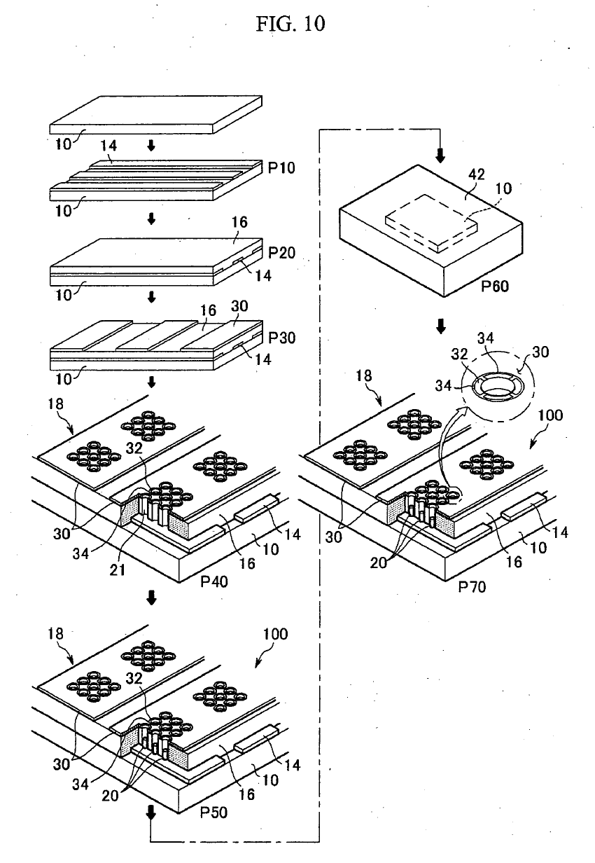

FIGS. 9 and 10 illustrate the steps of processing an electron emission device according to an embodiment of the present invention. Cathode electrodes 14 are formed on first substrate 10 with a predetermined pattern (P10). Subsequently, insulating layer 16 is formed on cathode electrodes 14 and first substrate 10 (P20). Main bodies 30 of gate electrodes 18 are formed on insulating layer 16 such that gate electrodes 18 cross cathode electrodes 14 (P30). Openings 21 are formed through main bodies 30 and insulating layer 16 to form electron emission regions 20, and simultaneously, isolated portions 32 and connectors 34 are formed around openings 21 (P40). Electron emission regions 20 are formed within the openings 21 (P50). The white balance of the screen for the partially completed electron emission device is tested while applying power to cathode and gate electrodes 14 and 18, and the pixels where the light emission uniformity is largely differentiated are identified (P60). At least one connector 34 is removed from any abnormally bright pixel among the pixels where the light emission uniformity is largely differentiated in order to control the light emission uniformity per pixel (P70).

The formation of cathode electrodes 14, insulating layer 16, main bodies 30 of gate electrodes 18 and electron emission regions 20 may be made using the common processing steps in various ways, and any further explanation beyond the foregoing detailed explanation will be omitted.

Process P30 for forming main bodies 30 of gate electrodes 18, and process P40 for forming isolated portions 32 and connectors 34 may be simultaneously conducted through photolithography. At this time, the process of forming openings 21 at the main bodies of gate electrodes 18 and insulating layer 16 maybe also conducted.

Process P60 of testing the white balance and identifying the light emission uniformity per pixel may be conducted using white balance tester 42 based on a vacuum chamber after electron emission unit 100 is formed on first substrate 10. Alternatively, such a process may be conducted using a while balance tester not based on the vacuum chamber after the first substrate with electron emission unit 100 and second substrate 12 with for the light emission unit are assembled and sealed to each other.

In case the white balance testing is made after only electron emission unit 100 is formed on first substrate 10, the pixels largely differentiated in the light emission uniformity per pixel are precisely checked, and specific connectors 34 are removed from the checked pixels during subsequent process P70 by using the direct precise laser processing.

By contrast, in case the white balance testing is conducted after the first and the second substrates are assembled and sealed to each other, the pixels largely differentiated in the light emission uniformity per pixel are precisely checked, and specific connectors 34 are removed from the checked pixels during subsequent process P70 using the laser processing. In order to prevent the anode electrode from being damaged due to the laser processing, a material 8 reactant with a specific wavelength of laser may be coated on connectors 34 during formation process P40.

When width of the connector 34 is in the range of between several micrometers (μm) to several micrometers (μm), the display image quality is not reduced even though the anode electrode may have become damaged due to the laser processing.

Although preferred embodiments of the present invention have been described in detail hereinabove, it should be clearly understood that many variations and/or modifications of the basic inventive concept herein taught which may appear to those skilled in the art will still fall within the spirit and scope of the present invention, as defined in the appended claims.

What is claimed is:

1. An electron emission device, comprising:
a substrate;
a plurality of spaced-apart cathode electrodes formed on one major surface of the substrate aligned in one direction along the substrate;
a plurality of gate electrodes disposed across the cathode electrodes, each gate electrode comprising a main body, isolated portions spaced-apart from the main body and surrounding corresponding electron emission regions, and a connector electrically interconnecting at least one of the isolated portions and the main body;
an electrically insulating layer interposed between the cathode electrodes and the gate electrodes; and
electron emission material placed on the cathode electrodes within corresponding ones of the regions via openings formed through the gate electrodes and the insulating layer.

2. The electron emission device of claim 1, comprised of the isolated portions being divided into two or more sub-portions within corresponding ones of openings, and at least one of the divided sub-portions being connected to the main body via a corresponding connector.

3. The electron emission device of claim 1, comprised of at least one of the connectors being cut to control the electron emission uniformity per pixel.

4. The electron emission device of claim 1, further comprising a focusing electrode perforated by a plurality of orifices aligned with the electron emission regions and disposed over the gate electrodes, and an additional insulating layer interposed between the gate electrodes and the focusing electrode.

5. An electron emission display, comprising:
first and second spaced-apart substrates facing each other;
cathode electrodes disposed with a first orientation on the first substrate;
gate electrodes separated from the cathode electrodes by an insulating layer, disposed across the cathode electrodes, each gate electrode comprising a main body, isolated portions spaced-apart from the main body and surrounding corresponding electron emission regions, and a connector electrically interconnecting at least one of the isolated portions and the main body;
electron emission material placed on the cathode electrodes within openings perforating the gate electrodes and the insulating layer;
phosphor layers formed on a surface of the second substrate; and
an anode electrode formed across a surface of the phosphor layers.

6. The electron emission display of claim 5, comprised of the isolated portions being divided into two or more sub-portions within corresponding ones of openings, and at least one of the divided sub-portions being connected to the main body via a corresponding connector.

7. The electron emission display of claim 5, comprised of at least one of the connectors being cut to control the electron emission uniformity per pixel.

8. The electron emission display of claim 5, further comprising a focusing electrode perforated by a plurality of orifices aligned with the electron emission regions and disposed over the gate electrodes, and an additional insulating layer interposed between the gate electrodes and the focusing electrode.

9. A method of manufacturing an electron emission device, the method comprising the steps of:
sequentially forming on a substrate, cathode electrodes, an insulating layer and main bodies of gate electrodes;
forming openings through main bodies of the gate electrodes and the insulating layer, and simultaneously, forming isolated portions spaced-apart and electrically isolated from the main bodies, and connectors electrically interconnecting the main bodies and the isolated portions;
forming electron emission regions within different ones of the openings;
testing uniformity of light emission for each pixel formed by an array of the regions while applying a potential difference across the cathode and the gate electrodes; and
selectively removing at least one connector from pixels determined to be abnormally bright in dependence upon differentiated uniformity in the light emission.

10. The method of claim 9, comprised of forming the isolated portions and the connectors simultaneously with the step of forming the main bodies.

11. The method of claim 9, comprised of making a determination that a pixel is abnormally bright by testing the uniformity in the light emission uniformity per pixel using a white balance tester based on a vacuum chamber.

12. The method of claim 9, comprised of making a determination that a pixel is abnormally bright by testing the uniformity in the light emission uniformity per pixel using a white balance tester after the substrate and another substrate with a light emission unit are assembled and sealed to each other.

13. The method of claim 9, comprised of selecting removing the at least one connector with a laser.

14. The method of claim 13, wherein the connectors are formed with a width of several micrometers (μm) to several tens of micrometers (μm).

15. The method of claim 9, comprised of adjusting electron emission uniformity of a pixel by selective cutting at least one of the connectors in each array.

16. An electron emission display constructed with the electron emission device of claim 1, comprising:
phosphor layers formed on a second substrate; and
an anode electrode formed across the phosphor layers.

17. The electron emission display of claim 16, comprised of the isolated portions being divided into two or more sub-portions within corresponding ones of openings, and at least one of the divided sub-portions being connected to the main body via a corresponding connector.

18. The electron emission display of claim 16, further comprising a focusing electrode perforated by a plurality of orifices aligned with the electron emission regions and disposed over the gate electrodes, and an additional insulating layer interposed between the gate electrodes and the focusing electrode.

19. The electron emission display of claim 16, comprising of the regions being grouped in a plurality of different, discrete pixels with each pixel comprised of:
a plurality of the regions spaced-apart and surrounded by a corresponding one of the isolated portions, and
the connectors distributed throughout the pixel in dependence upon differentiation in the uniformity of light emission between the pixels.

20. The electron emission display of claim 5, comprised of the regions being grouped into a plurality of different, discrete pixels with each pixel comprised of:
a plurality of the regions spaced-apart and surrounded by a corresponding one of the isolated portions, and
the connectors distributed throughout the pixel in dependence upon differentiation in the uniformity of light emission between the pixels.

21. An electron emission device manufactured according to the method of claim 9, comprised of the regions being grouped into a plurality of different, discrete pixels with each pixel comprised of:
a plurality of the regions spaced-apart and surrounded by a corresponding one of the isolated portions, and
the connectors distributed throughout the pixel in dependence upon differentiation in the uniformity of light emission between the pixels.
